(19) United States
(12) Patent Application Publication
(10) Pub. No.: US 2002/0153467 A1
(43) Pub. Date: Oct. 24, 2002

(54) Elastomeric damping elements and applications for reducing shock and vibration

(76) Inventors: Noel Allen, Burnsville, MN (US); Allen L. Arndt, Burnsville, MN (US); Robert James Monson, St. Paul, MN (US)

Correspondence Address: Glenn W. Bowen, Lockheed Martin Corporation, P.O. Box 64525, M.S. U2E25, St. Paul, MN, 55164, US

(21) Appl. No.: 10/177,408

(22) Filed: Jun. 20, 2002

Related U.S. Application Data
(63) Continuation of application No. 09/495,693, filed on Feb. 1, 2000.

(51) Int. Cl. F16M 13/00

(52) U.S. Cl. 248/562

(57) ABSTRACT

Shock and vibration eliminating elements are constructed of an elastomeric material, which is formed into shapes that have an elongated, generally trapezoidal cross-sectional area. Upper and lower mounting surfaces extend from the ends of the cross-sectional area. The upper and lower end mounting surfaces of the damping elements have integral, parallel surfaces that are used to mount the element to the two structures. The cross-sectional area of the damping elements locates the mounting surfaces so that a straight line normal to one of parallel mounting surfaces at one end of the cross-sectional area of a block, will not intersect the other mounting surface at the other end of the cross-sectional area. Thus, a force applied in a normal direction to one of the mounting surfaces will be translated into shear forces instead of comprehensive forces. This substantially increases the damping efficiency of the material for shock and vibrations, enabling it to eliminate forces that otherwise would be transmitted through the elastomeric body. A second damping material may be inserted into the interior of the elastomeric body to control the damping characteristics of the damping element.

### BACKGROUND OF THE INVENTION

1. Field of the Invention

This invention relates to unique elastomeric damping elements and combinations of such elements, including the employment of such elements in a damping system to control and minimize the harmful effects of shock and vibration on electronic equipment housed in cabinets.

2. Description of the Related Art

Elastomeric materials are employed extensively in applications where shock and vibration must be minimized. Such applications include sports equipment, tools, automobiles, airplanes, and many other types of apparatus. It is also becoming increasingly important to minimize failures due to impact forces applied to electronic equipment, such as digital computers, especially when such equipment is employed in harsh, rugged environments.

Previously, various elastomeric materials have been used or suggested for use to provide shock and/or vibration damping, as stated in U.S. Pat. No. 5,766,720 issued Jun. 16, 1998 to Yamagishi, et. al. These materials include natural rubbers and synthetic resins, such as polyvinylchlorides, polyurethane, polyamides, polystyrenes, copolymerized polyvinyl chlorides, and polyolefine synthetic rubbers, as well as, synthetic materials such as urethane, EPDM. styrene-butadiene rubbers, nitrites, isoprene, chloroprenes, propylene, and silicones. The particular type of elastomeric material employed is not critical, but urethane material sold under the trademark Sorbothane® is currently employed. The registrant of the mark Sorbothane® for urethane material is the Hamilton Kent Manufacturing Company (registration number 1208333), Kent, Ohio 44240.

The elastomeric elements employed in the prior art were commonly formed into typical geometric 3D shapes, such as spheres, squares, right circular cylinders, cones, rectangles, and the like, as illustrated in U.S. Pat. No. 5,776,720. These typical geometric shapes, however, did not satisfactorily eliminate the transfer of compressive forces through the damping device, and thus, did not minimize or eliminate shock and vibration to the degree accomplished by the devices of the invention.

### SUMMARY OF THE INVENTION

An elastomeric damping element is formed with an elongated trapezoidal cross-sectional shape, with a first flat mounting surface that extends parallel to the first flat mounting surface at a second end of the trapezoidal cross-section, and is located so that a line drawn normal to one of the flat mounting surfaces, will not intercept the other of the flat mounting surfaces. As an option, a space in the interior of the element may be provided, which is filled with particulate or fluid material that may be contained in a deformable package. Another elastomeric material that has different damping characteristics than the outer body of the element may be poured into the element so that it solidifies inside of it.

### BRIEF DESCRIPTION OF THE DRAWINGS

The present invention is described by reference to the drawings in which:

FIG. 1 is a perspective view of an elastomeric body constructed in accordance with the invention;

FIG. 2 is a perspective view of the damping elements that share a common base plate;

FIG. 3 is a trapezoidal cross-sectional view of the elastomeric body of FIG. 1 taken along the lines 2-2 of FIG. 1;

FIG. 4 is a partial cut-away view that shows a damping element that encloses an elastomeric insert that has different damping characteristics than the enclosing body, and

FIG. 5 is a perspective view of an inner cabinet for electronic equipment, which is isolated from an outer cabinet by the elastomeric bodies of FIG. 1.

### DESCRIPTION OF THE PREFERRED EMBODIMENT

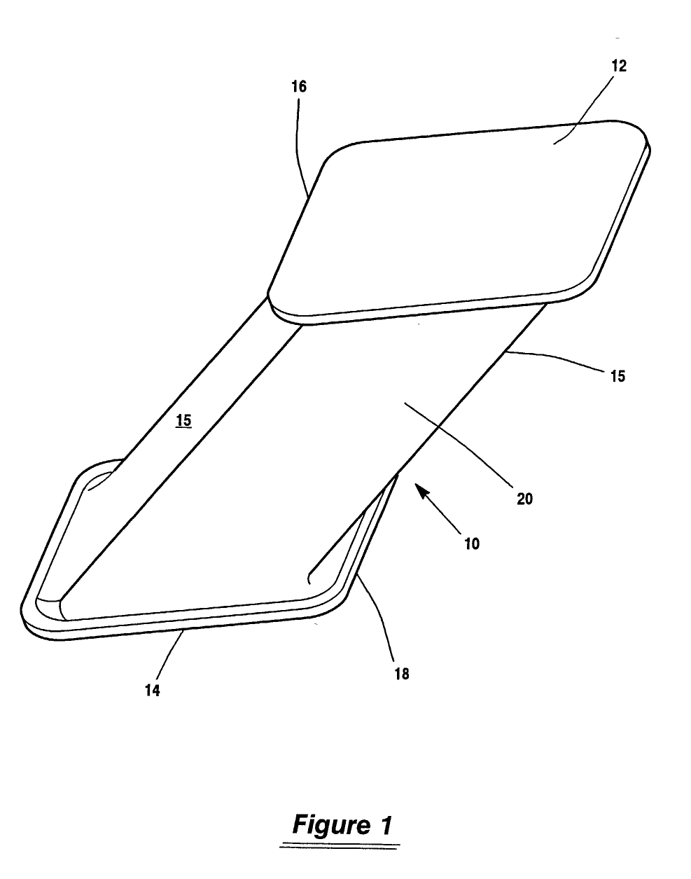

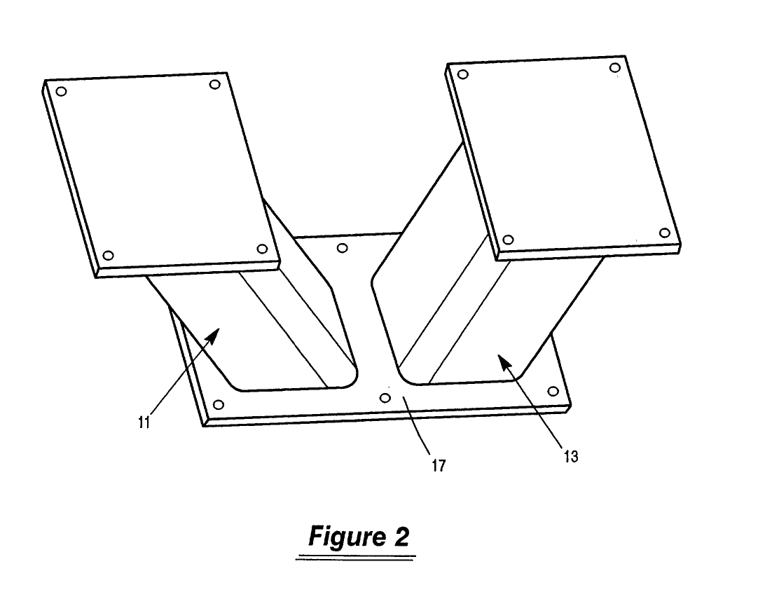

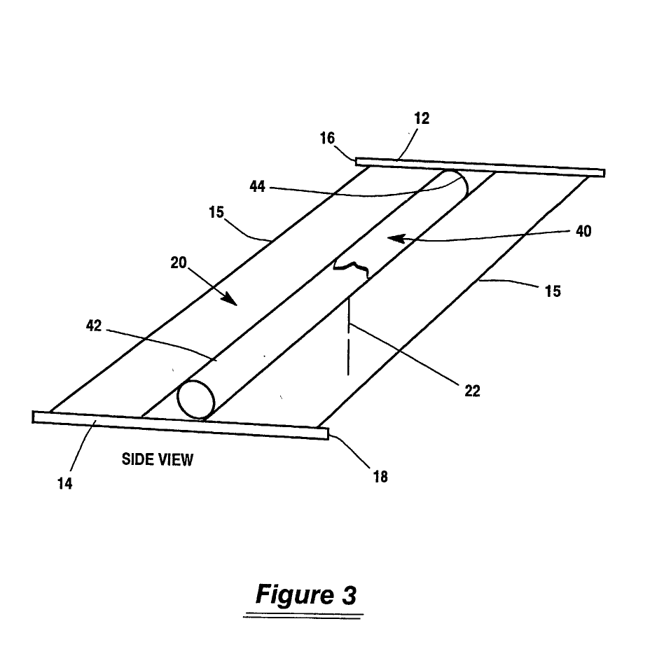

The preferred integral, high-bulk modulus, elastomeric element 10 of this invention is shown in FIG. 1. The end surfaces 12,14 of the body 20 of the element 10 are rectangular, but they may be circular, hexagonal or of other shapes, since the shape of the end surface is not important to the invention. FIG. 2 shows an alternate embodiment in which two damping elements 11,13 have a common base 17. The ends surfaces 12,14 may also be enlarged to provide a larger mounting surface, as shown in FIG. 3, but enlargement is not essential to the invention.

The body 20 is preferably formed with straight sides 15 along the long edge of the body. These sides, however, could be bowed inwardly or outwardly. The left-hand edge 16 of the upper end surface 12, is displaced from the right hand edge 18 of the lower end surface 14, so that the vertical line 22 (FIG. 3), that runs from the left edge 16 and normal to the end surface 12, is displaced from the right edge 18 of the end surface 14, so that it does not intersect any part of the end surface 14. FIG. 1, because it is a perspective view, does not show this, but the cross-sectional view of FIG. 2, taken along the lines 2,-2 of FIG. 1, does show the displacement. The cross-sectional view of FIG. 2, without the central channel 40, depicts one embodiment of FIG. 1. The inclusion of central channel 40 provides a second embodiment of the invention, which is described subsequently.

A downward applied force on the end surface 12 in the vertical direction of FIG. 3 will be translated into a downward and rightward displacement of the upper part of the body 20 relative to its lower part. This transforms the effect of the force into horizontal shear force, which, because of the residual elastomeric nature of the body, will greatly attenuate shock and vibration. This, consequently, prevents the transmission of compressive forces through the body 20, such as would occur if any portion of the end-mounting surface 12 overlaid any portion of the lower end mounting surface 14. FIG. 3, which is a view taken along the cutting lines 1,1 of FIG. 1, provides an elongated, generally trapezoidal cross-sectional view of the body. The sides 13 of the body are preferably straight in either embodiment, as shown in FIG. 2, but other shapes, including those with bowed sides, could be used to maintain edges 16,18 of the end surfaces 12,14 displaced from each other to convert forces that are applied to the end surfaces in a normal direction to end surfaces, into shear forces that are generally parallel to the end surfaces 12, 14.

In the second embodiment shown in FIG. 2, there is a central channel 40 which extends through the end surface 12, and at least partway through the body 20. A damping material 42, such as particulate tungsten carbide or a damping fluid, fills all or part of the hole. The damping material is preferably retained in a vinyl-jacketed, deformable cylinder or package 44, for ease of insertion into the channel 40. The type of material could be changed readily if a cap (not shown) was applied to one end of the hollow bore to allow for tuning of the damping performance of the element.

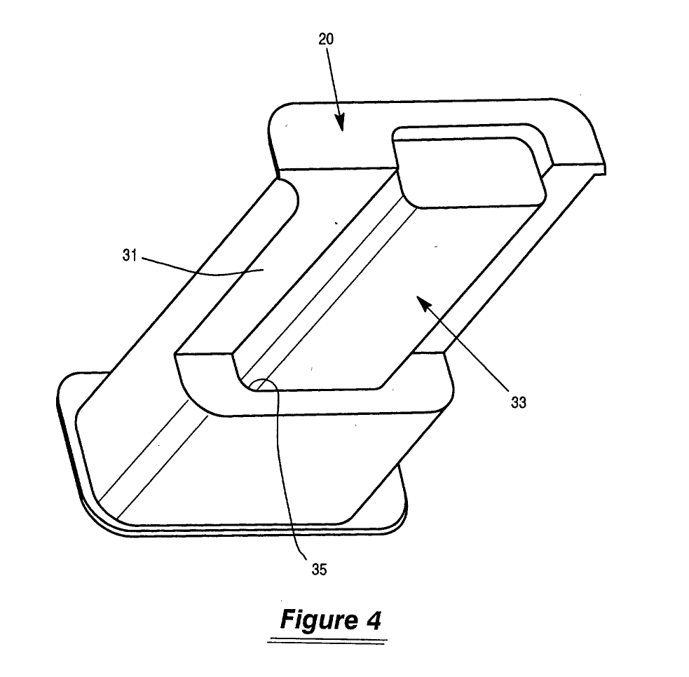

FIG. 4 shows another embodiment of the invention in which an outer body 31 of an elastomeric material 32 encloses an inner damping body 33 that has a shape that conforms to the shape of the outer body 20. The inner body preferably is of an elastomeric composition that has characteristics that differ from those of the outer body. A preferred construction of the embodiment of FIG. 4 is provided by pouring liquid Sorbothane® urethane into the cavity 35 of the outer body. When the Sorbothane urethane solidifies, the dissimilar material interface improves the damping system as well.

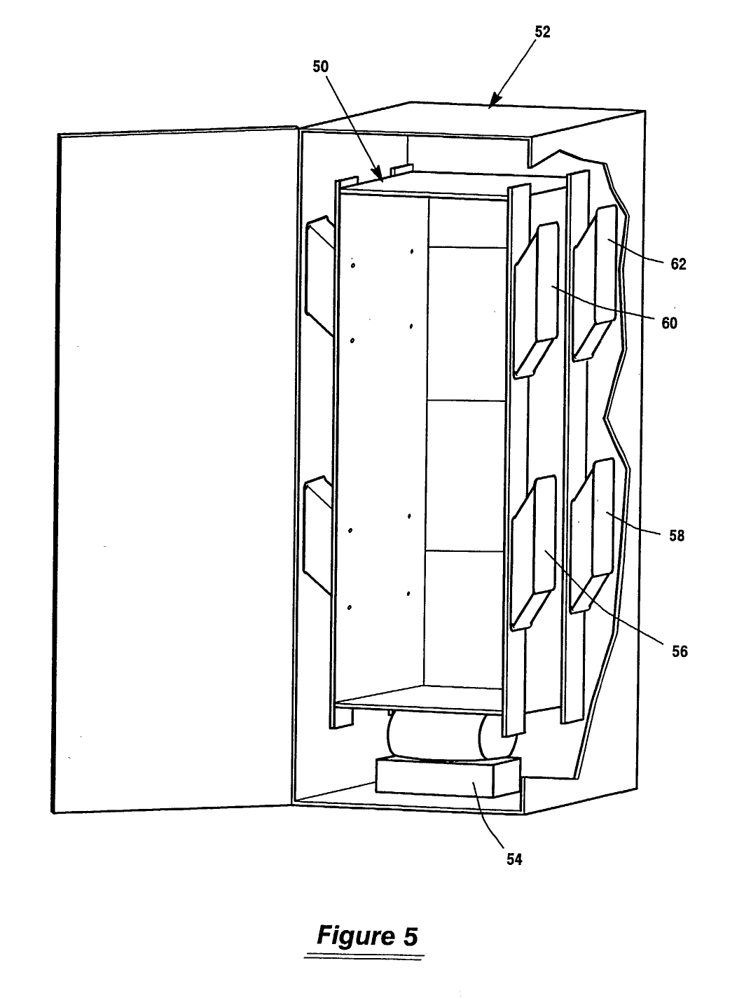

FIG. 5 illustrates the application of a elastomeric element to isolate an inner cabinet 50 for electronic equipment, from an outer cabinet 52, where the equipment is intended to be operated in a rugged environment where sudden or violent shocks may occur. The inner cabinet 50 is supported at the bottom of a suitable conventional mounting system 54. In the application illustrated in FIG. 5, eight elastomeric blocks are utilized, four in each side. The right-hand wall of the outer cabinet is removed to show the blocks 56-62. These blocks could be constructed in accordance with any of the illustrated embodiments, according to, or any variations that come within the scope of the appended claims. The blocks 56-62 are mounted between the frame of the inner cabinet 50 and the frame of the outer cabinet 52 on the right-hand side of FIG. 5. Four additional elastomeric blocks are mounted between the two cabinets 50, 52 on the left-hand side of FIG. 5. Mounting may be accomplished by applying adhesives to the mounting places, such as the product name “Scotch-Weld” No. 2216, sold by 3M company by damping the mounting plates in support brackets attached to the cabinets, or by other conventional methods.

The elastomeric element on this invention is easily manufactured at low costs and requires no maintenance in the field. This passive shock and vibration element has virtually instantaneous recovery from shock. Therefore, it provides equivalent protection under dynamic as well as static conditions. The invention provides a six-degrees of isolation from shock and vibrations. Although the elastomeric damping elements of the present invention are illustrated and described in connection with a preferred embodiment, the damping elements are very versatile, may be utilized for many different purposes, and may constructed to be very large or quite small in accordance with the intended application.

What is claimed is:

1. A damping element comprising an elastomeric body that has an elongated, cross-sectional area formed in the shape of a parallelogram, a first mounting surface located at a first end of said cross-sectional area, and a second mounting surface that extends parallel to said first mounting surface located at a second end of said cross-sectional area such that said first and second mounting surfaces are intended to be mounted to surfaces that apply compressive forces normal to said mounting surfaces, wherein said damping element is shaped such that a straight line drawn normal to any portion of either of said mounting surfaces will not intersect any portion of said other mounting surface.

2. An elastomeric damping element as claimed in claim 1, comprising a channel in said elastomeric body that has a central axis which extends through at least one of said mounting surfaces, and at last party-way through said elastomeric body along said central axis of said channel and damping material is inserted in said channel so as to partially fill said channel.

3. An elastomeric damping element as claimed in claim 2, comprising a package that contains said damping material when said damping material is in said channel.

4. An elastomeric damping element as claimed in claim 2 wherein said damping material is in a liquid state.

5. An elastomeric damping element as claimed in claim 1, wherein said elastomeric body has a cavity therein that is filled by an elastomeric filling material that has elastomeric characteristics that are different from those of said elastomeric body.

6. An elastomeric damping element as claimed in claim 5, wherein said elastomeric filling material is poured into said cavity while said material is in a liquid state.

7. A new use of a damping element comprising an elastomeric body that has an elongated, cross-sectional area formed in the shape of a parallelogram, a first mounting surface located at a first end of said cross-sectional area, and a second mounting surface that extends parallel to said first mounting surface located at a second end of said cross-sectional area, wherein said damping element is shaped such that a straight line drawn normal to any portion of either of said mounting surfaces will not intersect any portion of said other mounting surface comprising, securing said first mounting surface to a first substantially flat surface, and securing said second mounting surface to a second substantially flat mounting surface, wherein said first and second substantially flat mounting surfaces are subject to compressive forces that are applied normal to said mounting surfaces.

8. A new use of an elastomeric damping element as acclaimed in claim 7, comprising a channel in said elastomeric body that has a central axis which extends through at least one of said mounting surfaces, and at last part-way through said elastomeric body along said central axis of said channel and damping material is inserted into said channel so as to partially fill said channel.

9. A new use of an elastomeric damping element as claimed in claim 8, comprising a package that contains said damping material when said damping material is in said channel.

10. A new use of elastomeric damping element as claimed in claim 8, wherein said damping material is poured into said cavity while said damping material is in a liquid state.

11. A new use of an elastomeric damping element as claimed in claim 7, wherein said elastomeric body has a cavity therein that is filled by an elastomeric filling material that has elastomeric characteristics that are different from those of said elastomeric body.

12. A new use of an elastomeric damping element as claimed in claim 11, wherein said elastomeric filling material is poured into said cavity while said material is in a liquid state.
